(19) United States
(12) Patent Application Publication
(10) Pub. No.: US 2022/0105896 A1
(43) Pub. Date: Apr. 7, 2022

(54) AUXILIARY SYSTEM ASSISTANCE FOR AUTOMATIC PARKING

(71) Applicant: Toyota Motor Europe, Brussels (BE)

(72) Inventors: Paul GIROND, Brussels (BE); Yuichi SAKAI, Brussels (BE)

(73) Assignee: Toyota Motor Europe, Brussels (BE)

(21) Appl. No.: 17/426,861

(22) PCT Filed: Jan. 31, 2019
(86) PCT No.: PCT/EP2019/052417

§ 371 Date: Jul. 29, 2021

(51) Int. Cl. B60R 25/10; B60R 25/01; B60W 30/06; B60R 25/102; E05F 15/70

(52) U.S. Cl. CPC B60R 25/1003; B60R 25/01; B60W 30/06; B60R 25/102; E05B 81/56; B60R 2325/205; E05Y 2400/45; E05Y 2900/55; E05F 15/70

(57) ABSTRACT

An auxiliary system assistance method for a vehicle is provided. The method includes receiving a request to commence automated parking, determining a status of a user-selected security flag for securing auxiliary systems of the vehicle in response to the request, triggering securing of the vehicle immediately prior to commencement of the automated parking based on the status of the user-selected security flag, and then commencing automated parking of the vehicle.

### CROSS-REFERENCE TO RELATED APPLICATION

This application is a National Phase Application of International Application No. PCT/EP2019/052417, filed on Jan. 31, 2019. The entire disclosure of the above application is incorporated herein by reference

### FIELD OF THE DISCLOSURE

The present disclosure relates to a vehicle provided with automatic parking features. More particularly, the present disclosure relates to an automated system for securing a vehicle following an auto-parking command.

### BACKGROUND OF THE DISCLOSURE

Self-parking systems for a motor vehicle have been implemented in various automotive models in recent years. These systems enable an operator of the vehicle to instruct a vehicle, either the ego vehicle or a robotic guide, to conduct autonomous operation resulting in parking of the vehicle in a parking spot.

In addition, automated vehicle parking has been implemented at various public and private parking facilities with an eye toward improving, e.g., parking density and operator experience in such facilities.

According to some implementations, a vehicle may enter an autonomous driving mode following an indication from an operator for automatic parking, and circulate throughout a parking area in search of a vacant parking spot. According to some further implementations, a parking management service may be in operation at a parking facility (e.g., a server having communication abilities with vehicles to be parked), and may “direct” a vehicle to an identified vacant spot.

Certain aspects of a vehicle during automatic parking may render the vehicle more likely to be compromised, e.g., entered and/or burgled. For example, because the parking operation is automatic, an operator may be inclined to initialize the parking sequence, and then leave the area surrounding the vehicle, to perform intended functions at a nearby location (e.g., shopping). When the operator leaves the vehicle, the operator may omit or otherwise forget an action of fully securing the vehicle, for example, closing open windows and/or locking the doors. This may be a particularly prevalent issue in warm weather.

Some systems have attempted to detect whether a user is still in the vehicle, and if not, attempts to secure the vehicle by closing the windows. For example, CN 2856352 discloses a system for determining the presence of humans in the vehicle, and closing the windows when no one is detected inside.

KR 2002 00447078 discloses a system for closing windows of a vehicle when the ignition key of the vehicle is removed.

KR 2004 0039632 discloses a system for detecting rain and locking of doors, and closing the windows of the vehicle in response thereto.

### SUMMARY OF THE DISCLOSURE

The inventors have recognized that there is a need for an improved automated system for securing the vehicle at particular phases of the automated parking procedure would be beneficial in the market. The inventors have further recognized that sensing whether humans are present in vehicle and using this as a trigger for securing the vehicle can present issues. For example, additional sensors are required in order to detect the present of humans in the vehicle, leading to increased manufacturing costs. Further, the sensors may fail to detect the presence of a human, despite there being a human in the vehicle. This can cause safety issues.

An auxiliary system assistance method for a vehicle, comprising: receiving a request to commence automated parking, determining a status of a user-selected security flag for securing auxiliary systems of the vehicle in response to the request, triggering securing of the vehicle immediately prior to commencement of the automated parking based on the status of the user-selected security flag, and commencing automated parking of the vehicle.

By providing such a system, automation of the securing of the vehicle may be performed prior to commencement of automated parking, thereby reducing the opportunity for intrusion into the vehicle. Further, because the securing is performed in response to an acknowledgement to commence automated parking, the likelihood that the operator remains in the vehicle during or after the securing is low, and the need for detecting the presence of humans in the vehicle can be reduced or even eliminated.

The auxiliary system assistance method may comprise, identifying one or more windows of the vehicle having a position status of open, and when the user-selected security flag is set, triggering closure of the one or more windows having the position status of open.

The user-set security flag may be stored and manipulated via a remote terminal located remotely from the vehicle.

The remote terminal may comprise a device selected from a smartphone and a personal computer.

The request to commence automated parking and the user-set security flag may be transmitted from the remote terminal to a gateway device of the vehicle.

The user-set security flag may be stored in an ECU of the vehicle.

The auxiliary system assistance method may include causing at least one of visual, haptic, or audio feedback when securing of the vehicle has completed.

The feedback may include audio from inside the vehicle, for example, as obtained from a microphone installed inside the vehicle.

The feedback may be provided at the remote terminal.

### BRIEF DESCRIPTION OF THE DRAWINGS

The present disclosure may be better understood and its numerous other objects and advantages will become apparent to those skilled in the art by reference to the accompanying drawing wherein like reference numerals refer to like elements in the following figures and in which:

FIG. 1 shows a schematic representation of an exemplary system according to embodiments of the present disclosure;

FIG. 2 is a flowchart showing an exemplary method according to embodiments of the present disclosure.

### DESCRIPTION OF THE EMBODIMENTS

Embodiments the present disclosure may enable securing of a vehicle immediately following confirmation of an automated parking action.

Automated parking operations are generally known in the art, and autonomous driving tasks and systems used to carry out such tasks (e.g. cameras, sensors, controllers, etc.) are well known. Therefore, a detailed description of automated parking operations and control of the vehicle during such operations will not be undertaken herein.

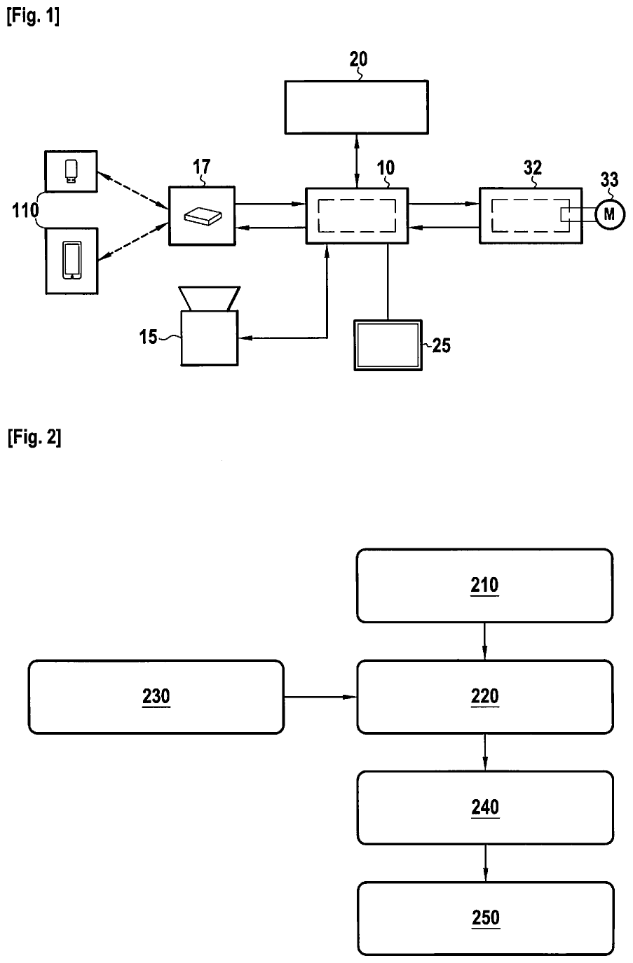

FIG. 1 shows an exemplary auxiliary system assistance configuration 1 according to embodiments of the present disclosure. The system 1 may include processing means, such as an electronic control unit (ECU) 10, image obtaining means 15 such as a camera, one or more sensors 20, a system controller 32, a display 25, and a telecommunications module 17, among others.

Image obtaining means 15 may include, for example, one or more cameras and/or other suitable devices configured to obtain optical data from an area surrounding a vehicle (e.g., in front of a forward moving vehicle). Image obtaining means 15 may be configured to process the data obtained from the surroundings of the vehicle to aid in execution of an automated parking operation. Such image obtaining means 15 are known in the art, and one of skill in the art will understand that any such image obtaining means 15 may be implemented in the present system without departing from the scope of the present disclosure.

Remote terminal 110 may comprise any suitable device for sending and receiving information between the telecommunications module 17 and a user, e.g. an operator of the vehicle. For example, remote terminal 110 may comprise, among others, a handheld device such as a smart phone, a smart key and/or a digital assistant, or may be a larger fixed or mobile type device, for example, a personal computer, a kiosk, etc.

Remote terminal 110 may comprise a display configured to provide or receive information to/from a user, for example, the status of a user selected security flag, a request to being an automated parking operation, etc.

In order to provide means for such selections, remote terminal 110 may include an operating system and one or more applications suitable for receiving such selections, as well as for enabling communications between remote terminal 110 and telecommunications module 17 to provide such selections.

One of skill understands that devices comprising remote terminal 110 are known in the art, and further discussion of the components thereof will not be undertaken herein.

Telecommunications module 17, may comprise a receiver and a transmitter, among others, and be configured to communicate with devices (e.g., terminals) remote from the system and the vehicle on which the system is mounted.

Telecommunications module 17 may be configured to transmit and receive information related to an automated parking operation via a wireless and/or wired signal from within or remotely to the vehicle. Therefore, telecommunications module 17 may be configured to, for example, transmit a request for information regarding an empty parking space, receive user-selected security options, receive a request to commence a parking operation, etc.

Telecommunications module 17 may be configured to transmit and receive information regarding a selected option or options from a user and may subsequently provide such information to ECU 10. For example, according to some embodiments, a user selected security flag may be stored at ECU 10, and may be set and/or otherwise modified at a remote terminal 110 available to a user. Therefore, upon modification or selection of the user selected security flag, telecommunications module 17 may first transmit a current value of the user selected security flag to a remote terminal, and then subsequently receive a user selection modifying the user selected security flag.

Telecommunications module 17 may be further configured to receive, for example, a request to commence automated parking, among others. Such a request may come from, for example, the remote terminal, and in vehicle information system, etc. One of skill will recognize that such options are not to be considered limiting, and a request to initiate or commence automated parking may come from any suitable location and device.

ECU 10 may include any suitable device configured to manipulate data, perform calculations, execute code for decision making, and causing display of information to an operator of the vehicle, in order to carry out embodiments of the present disclosure. For example ECU 10 may include various analog and/or digital circuits, and may include integrated circuits such as RISC processors, i386 processors, ASIC processors, etc. Typically, on-board computers in modern vehicles include such processors, and one of skill will understand that the present ECU 10 may be comprised by such an on-board computer, or may be separately provided. One of skill in the art will also understand that the exemplary circuits and processors described herein are not intended to be limiting, and that any suitable device may be implemented.

ECU 10 may be linked to one or more databases and/or other memory (e.g., RAM, ROM, etc.) associated with the vehicle so as to enable storage of vehicle related data as well as values that may be utilized during processing of vehicle functions (e.g., a user-selected security flag), such as automated securing of the vehicle. One of skill in the art will recognize that information discussed herein with regard to any such databases and/or memory is not intended to be limiting.

ECU 10 may be configured to receive data from one or more sensors 20, telecommunications module 17, and system controller 32, among others, providing functionality associated with the present disclosure. For example ECU 10 may receive data regarding a status/position of one or more motors 33, among others.

Display 25 may be configured to display information provided by ECU 10 to an operator of the vehicle. While FIG. 2 shows an exemplary display 25 connected to vehicle systems, and providing information that may be of interest to a operator of the vehicle, one or more displays 25 may also be present on remote terminal 110, a kiosk (not shown), etc. As shown at FIG. 2, a valid speed limit is among the information currently displayed to a driver on display 25.

Display 25 may be any suitable device for providing visible and/or audible information to a driver of vehicle 2. For example, display 25 may include a heads up display (e.g., on a windshield in front of a driver), a monitor, an in-dash display, etc.

The vehicle may include one or more system controllers 32, which may be configured to receive information and/or commands from ECU 10, and to execute those commands to control various vehicle systems (e.g., steering, braking, door locks, windows, etc.). For example, the vehicle may comprise a parking controller, a body function controller, and a primary systems controller. Such devices may be configured to actively manipulate system controllers 32 of the vehicle, for example, to operate a steering system, a braking system, an acceleration system, etc. to automatically park the vehicle, as well as motors/actuators 33 (e.g., servo motors) associated with, for example, door locks, windows, etc. of the vehicle.

Such devices may include one or more servo motors/actuators 33, etc., which may receive instructions from one or more systems of the vehicle and/or an operator, for example ECU 10. Based on these instructions, system controller 32 may cause securing of the vehicle by closing windows and locking doors, for example.

Motors/actuators 33 may be configured to provide a status (e.g., open/closed, locked/unlocked, etc.) regarding one or more windows of the vehicle, and/or one or more door locks of the vehicle to ECU 10, and/or systems controller 32. Such information may be used for determining whether to actuate the motor/actuators 33 in response to a parking request for purposes of securing the vehicle.

FIG. 2 is a flowchart showing an exemplary method according to embodiments of the present disclosure. According to embodiments of the disclosure, and exemplified at step 230 of FIG. 2, an operator, may set and/or modify one or more remote parking parameters, among which, may be, for example, a user selected security flag indicating a desire to secure the vehicle at commencement of an automated parking operation. Such setting and/or modifying may take place on a remote terminal 110, in the vehicle via for example, the vehicle information system, etc. The remote parking parameters may then be stored by ECU 10 in memory present on the vehicle, and/or at remote terminal 110, for example.

Remote parking parameters may include one or more values (e.g., binary, string, etc.) configured to store a user preference for remote parking operations. For example, a user selected security flag for securing a vehicle may comprise a binary indicator representing a true/false (0/1) scenario, “true” indicating the a vehicle should be secured immediately prior to commencement of the automated parking, and “false” indicating no securing should be undertaken.

Alternatively, such a flag may be configured to indicate additional information based on a value thereof. For example, securing windows, securing door locks, both options, or neither etc., may be conveyed based on a value of 0-3. Where 0 indicates no securing, 1 indicating securing of windows only, 2 indicating securing of locks only, and 3 indicating both locks and windows should be secured. Additional schemes for values of the user-selected security flag may be implemented without departing from the scope of the present disclosure.

According to embodiments of the disclosure, when an operator for example, arrives at a desired location, the operator may utilize a remote terminal 110 for indicating his intention to start remote parking. Such an acknowledgment may be performed by, for example, clicking an option button in response to a prompt displayed on remote terminal 110 requesting whether such automated parking operation should begin (step 210). As previously noted, such an acknowledgement could also be provided from the vehicle information system, a kiosk, etc., and received via telecommunications module 17.

Upon receiving the acknowledgment, telecommunications module 17 may send the acknowledgment to ECU 10 causing ECU 10 to trigger a check of the remote parking parameters stored in a memory of the vehicle, or provided along with the acknowledgment (e.g., from remote terminal 110), to determine the status of a user selected security flag for securing auxiliary systems of the vehicle (step 220).

When the remote parking parameters include the user selected security flag indicating that the securing of the auxiliary systems of the vehicle should be undertaken (e.g., a binary indicator of true, a value of 1, 2, or 3, etc.), ECU 10 may cause triggering of systems controller 32 such that one or more motors/actuators 33 are operated so as to secure the vehicle (step 240). For example, one or more motors 33 used for raising and lowering one or more windows of the vehicle, may provide information regarding a status of the associated window (e.g., open or closed) and where that status indicates a position status of open, operate the motor 33 to close the window. Similarly, where one or more door locks indicate a status of open or unlocked, systems controller 32 may cause an appropriate action so as to lock the unlocked door locks.

The securing of the vehicle may be triggered immediately following receipt of the acknowledgement from an operator to begin the automated parking operation, and immediately prior to commencing said operation (step 250). In so doing, intrusion opportunities into the vehicle can be limited, while also maintaining a desirable level of safety for occupants (previous occupants) of the vehicle. The term “immediately,” as used here shall mean within 0-5 seconds of the time of the described action.

One of skill will understand that various modifications may be made without departing from the scope of the present disclosure. For example, according to some embodiments, during and/or following securing of the vehicle, feedback may be provided to the operator of the vehicle via the remote terminal 110, a kiosk, etc. For example, feedback may include visual, haptic, and/or audio based feedback, and may, according some embodiments, include audio from inside the vehicle. For example were the vehicle comprises a microphone on the inside of the vehicle, an operator may hear the sounds of the one or more windows closing and the doors locking via an audio output of the remote terminal 110.

According to a further example, remote terminal 110 may vibrate when securing of the vehicle is complete, for example using an internal vibrator of the remote terminal 110.

Alternatively, or in addition, a sound may be played from remote terminal 110 to indicate that the securing has been completed successfully, or a different sound to indicate that there has been a problem securing the vehicle (e.g., a window is blocked from being raised).

The feedback may therefore be configured to provide an operator with a feeling of security with regard to intrusion opportunities of the vehicle.

Although the present disclosure herein has been described with reference to particular embodiments, it is to be understood that these embodiments are merely illustrative of the principles and applications of the present disclosure.

Where any standards of national, international, or other standards body are referenced (e.g., ISO, SAE, etc.), such references are intended to refer to the standard as defined by the national or international standards body as of the priority date of the present specification. Any subsequent substantive changes to such standards are not intended to modify the scope and/or definitions of the present disclosure and/or claims.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

It is intended that the specification and examples be considered as exemplary only, with a true scope of the disclosure being indicated by the following claims.

1. An auxiliary system assistance method for a vehicle, the method comprising:
receiving a request to commence automated parking;
determining a status of a user-selected security flag for securing auxiliary systems of the vehicle in response to the request;
triggering securing of the vehicle immediately prior to commencement of the automated parking based on the status of the user-selected security flag; and
commencing automated parking of the vehicle.

2. The auxiliary system assistance method according to claim 1, the securing comprising:
identifying one or more windows of the vehicle having a position status of open; and
when the user-selected security flag is set, triggering closure of the one or more windows having the position status of open.

3. The auxiliary system assistance method according to claim 1, wherein the user-selected security flag is stored and manipulated via a remote terminal located remotely from the vehicle.

4. The auxiliary system assistance method according to claim 3, wherein the remote terminal comprises a device selected from a smartphone and a personal computer.

5. The auxiliary system assistance method according to claim 3, wherein the request to commence automated parking and the user-selected security flag are transmitted from the remote terminal to a gateway device of the vehicle.

6. The auxiliary system assistance method according to claim 3, wherein the user-selected security flag is stored in an ECU of the vehicle.

7. The auxiliary system assistance method according to claim 1, further comprising causing at least one of visual, haptic, or audio feedback when securing of the vehicle has completed.

8. The auxiliary system assistance method according to claim 7, wherein the feedback includes audio from inside the vehicle.

9. The auxiliary system assistance method according to claim 3, further comprising causing at least one of visual, haptic, or audio feedback when securing of the vehicle has completed, the feedback being provided at the remote terminal.
